(19) United States
(12) Patent Application Publication
(10) Pub. No.: US 2023/0289615 A1
(43) Pub. Date: Sep. 14, 2023

(54) TRAINING A MACHINE LEARNING MODEL

(71) Applicant: Telefonaktiebolaget LM Ericsson (publ), Stockholm (SE)

(72) Inventors: Konstantinos Vandikas, SOLNA (SE); Wenfeng Hu, TÄBY (SE); Jalil Taghia, STOCKHOLM (SE); Vlasios Tsiatsis, STOCKHOLM (SE); Selim Ickin, STOCKSUND (SE); Farnaz Moradi, STOCKHOLM (SE)

(21) Appl. No.: 18/011,575

(22) PCT Filed: Jun. 26, 2020
(86) PCT No.: PCT/EP2020/068034

§ 371 Date: Dec. 20, 2022

(51) Int. Cl. G06N 3/098; H04W 24/02

(52) U.S. Cl. CPC G06N 3/098; H04W 24/02

(57) ABSTRACT

A method in a first node of a communications network for training a machine learning model comprises receiving a first message comprising instructions for training the machine learning model using a distributed learning process. The method then comprises responsive to receiving the first message, acting as an aggregator in the distributed learning process for a subset of other nodes selected by the first node from a plurality of nodes that have an established radio channel allocation with the first node, by causing the subset of other nodes to perform training on local copies of the machine learning model and aggregating the results of the training by the subset of other nodes.

### TECHNICAL FIELD

This disclosure relates to methods, nodes and systems in a communications network. More particularly but non-exclusively, the disclosure relates to training a machine learning model in a communications network.

### BACKGROUND

Machine learning is extensively used in order to generate predictive models for various scenarios such as speech recognition, speech synthesis, machine translation and other problems. Machine learning models such as neural networks are trained using training data comprising example input data and corresponding ground truth (e.g. “correct”) outputs for each example input. Machine learning models require large volumes of such training data in order to produce a good representation of a dataset and thus high predictive capability. Over time, accessing suitable data for use in training machine learning models has become increasingly difficult since in a lot of cases it requires accessing private data and/or moving private data to large data storage facilities for processing and training of the model to take place.

Distributed learning techniques such as Federated Learning (see for example the paper by Bonawizt et al. 2019 entitled “Towards Federated Learning at Scale”) improve on this problem by allowing machine learning models to be trained locally, e.g. as close as possible to where the data is generated. Local models produced on “the edge” are then averaged together. This is performed iteratively until the averaged model's accuracy converges. In such learning schemes, the training data does not need to be moved (or does not need to be moved as far) from its source, as model parameters such as weights and biases are sent to aggregating points instead of the underlying data being sent itself.

Federated learning alone however may not be enough to ensure privacy since model parameters (such as neural parameters) that are transferred can still be reverse engineered by attacks such as “Deep Leakage” (see for example the paper by Zhu et al. 2019 entitled “Deep Leakage from Gradients”)—consequently re-producing the ground truth—e.g. the original dataset that was used.

### SUMMARY

As noted above, one challenge with distributed learning techniques is that ground truth data (e.g. the private data used to train the machine learning model) may be reverse engineered from model parameters using techniques such as Deep Leakage. Techniques such as Secure Aggregation (see, for example, the paper by Bonawitz et al. 2017, entitled: “Practical Secure Aggregation for Privacy-Preserving Machine Learning”) have been considered to mitigate reverse engineering attacks by allowing a mask to be computed/negotiated between those participating in the federation which ultimately obfuscates the neural parameters produced by each participant in such a way that the federated averaging process can still be performed but by ruling out the possibility of reproducing the original dataset of each party.

Implementing Secure Aggregation in such a manner increases the complexity however, to the order of O(n²) where n is the number of workers (e.g. devices training local copies of the model)—which means that a federation with 1 aggregation point and 100 remote workers would require 100²=10000 interactions. In the general case, most algorithms in the area of secure multi-party computation (such as Secure Aggregation) suffer with similar complexity problems. Partitioning techniques can be used to solve this problem—instead of aggregating between 1 and 100 remote workers we can create a hierarchy of 1:10:10 workers which means that the total number of interactions is now (1*10²)+(10*10²)=11*(10²) (10 workers at every federation−2 levels of federations)=1100. This is illustrated in FIG. 1 which shows a federated learning scheme with a single aggregation point 102 that coordinates a hundred user equipments (UEs) 104, and results in 10000 messages sent between the aggregator 104 and UEs 104. A scheme having two layers whereby an aggregator 106 coordinates layers 108 which interact with UEs 110 may reduce the number of messages that need to be sent by a factor of approximately 10.

Data centers are often chosen as platforms to perform federated averaging, e.g. to become aggregation points, by instantiating multiple such processes per federation as it is spread geographically. Even though this can be a good solution, it may require creating multiple processes for every group of devices that need to participate in a federation and this can increase the cost of using the data center. More so, depending the location of the UE and the location of the data center there may be greater latency and even a risk of break out to the public internet until the model that is trained locally on a UE arrives at the data center to be averaged together with other models. Latency in such cases can be crucial since input from all workers at each level of a federation is expected in order for federated averaging to be performed and as such, the slowest worker can delay the entire federation.

Embodiments herein thus aim to address some of the aforementioned challenges associated with distributed learning when training a machine learning model.

In a first aspect there is a method in a first node of a communications network for training a machine learning model. The method comprises receiving a first message comprising instructions for training the machine learning model using a distributed learning process. The method further comprises responsive to receiving the first message, acting as an aggregator in the distributed learning process for a subset of other nodes selected by the first node from a plurality of nodes that have an established radio channel allocation with the first node, by causing the subset of other nodes to perform training on local copies of the machine learning model and aggregating the results of the training by the subset of other nodes.

In this manner a first node is able to establish a hierarchy in a distributed machine learning process, by establishing itself as an aggregator for nodes with which it already has an established radio channel allocation with. Thus instead of a datacenter determining a partitioning for a distributed learning process (e.g. based on geography of the underlying nodes, for example) the natural association between different nodes (e.g. UEs and gNBs) from a coverage perspective can be leveraged to provide a natural way of partitioning each set of nodes with their corresponding aggregation point. This method can be used in an iterative fashion whereby each node acts as an aggregation point for successive subsets of other nodes with which they have established radio channel allocations. This reduces the computing load on the datacenter as the data no longer has to calculate or determine partitions. It further reduces the load on the network as nodes do not need to establish new radio connections with other nodes (e.g. in order to set up connections for an arbitrary partitioning determined by a datacenter) in order to implement the method.

According to a second aspect there is a method in a second node of a communications network for training a machine learning model. The method comprises sending a first message to a plurality of first nodes, the first message comprising instructions for training the machine learning model using a distributed learning process wherein the first message causes each first node in the plurality of first nodes to act as an aggregator in the distributed learning process for a subset of other nodes, selected by the respective first node, that have an established radio channel allocation with the respective first node.

According to a third aspect there is a method in a user equipment, UE, of a communications network for training a machine learning model. The method comprises receiving a second message from a first node in the communications network with which the UE has an established radio channel allocation, the second message comprising instructions for training the machine learning model using a distributed learning process. The method further comprises training a local copy of the machine learning model, according to the instructions. The method further comprises sending a third message comprising a result of the training to the first node for aggregation by the first node with results of training performed by other UEs.

According to a fourth aspect there is a first node in a communications network for training a machine learning model. The first node comprises a memory comprising instruction data representing a set of instructions and a processor configured to communicate with the memory and to execute the set of instructions. The set of instructions, when executed by the processor, cause the processor to receive a first message comprising instructions for training the machine learning model using a distributed learning process and responsive to receiving the first message, act as an aggregator in the distributed learning process for a subset of other nodes selected by the first node from a plurality of nodes that have an established radio channel allocation with the first node, by causing the subset of other nodes to perform training on local copies of the machine learning model and aggregating the results of the training by the subset of other nodes.

According to a fifth aspect there is a second node in a communications network for training a machine learning model. The second node comprises a memory comprising instruction data representing a set of instructions and a processor configured to communicate with the memory and to execute the set of instructions. The set of instructions, when executed by the processor, cause the processor to send a first message to a plurality of first nodes, the first message comprising instructions for training the machine learning model using a distributed learning process wherein the first message causes each first node in the plurality of first nodes to act as an aggregator in the distributed learning process for a subset of other nodes selected by the respective first node that have an established radio channel allocation with the respective first node.

According to a sixth aspect there is a user equipment, UE, for training a machine learning model, the UE comprising a memory comprising instruction data representing a set of instructions, and a processor configured to communicate with the memory and to execute the set of instructions. The set of instructions, when executed by the processor, cause the processor to receive a second message from a first node, in the communications network with which the UE has an established radio channel allocation, the second message comprising instructions for training the machine learning model using a distributed learning process; train a local copy of the machine learning model, according to the instructions, and send a third message comprising a result of the training to the first node for aggregation by the first node with results of training performed by other UEs.

According to a seventh aspect there is a computer program product comprising a computer readable medium, the computer readable medium having computer readable code embodied therein, the computer readable code being configured such that, on execution by a suitable computer or processor, the computer or processor is caused to perform the method of the first, second or third aspects.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows prior art hierarchies of nodes in a distributed learning scheme;

FIG. 2 shows a hierarchy of nodes in a distributed learning scheme according to embodiments here;

FIG. 3 shows a first node according to some embodiments herein;

FIG. 4 shows a method in a first node of training a machine learning model according to some embodiments herein;

FIG. 5 shows a second node according to some embodiments herein;

FIG. 6 shows a method in a second node of training a machine learning model according to some embodiments herein;

FIG. 7 shows a user equipment according to some embodiments herein;

FIG. 8 shows a method in a user equipment of training a machine learning model according to some embodiments herein; and

FIGS. 9a-c show an example signal diagram according to some embodiments herein.

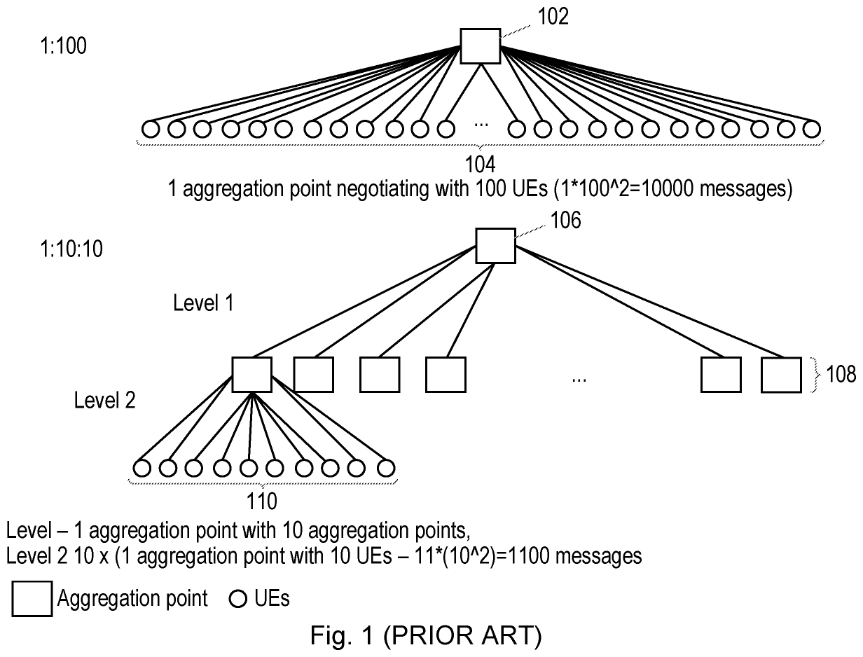

### DETAILED DESCRIPTION

As described above, distributed learning processes such as Federated Learning that are used to train machine learning models can result in large numbers of messages needing to be sent around a network, particularly when training updates are aggregated by a datacentre and/or secure multi-computation techniques are used. Furthermore as noted above, there are privacy concerns associated with transmitting training data, and even model parameters around a network. It is an object of embodiments herein to improve on distributed learning processes for training a machine learning model.

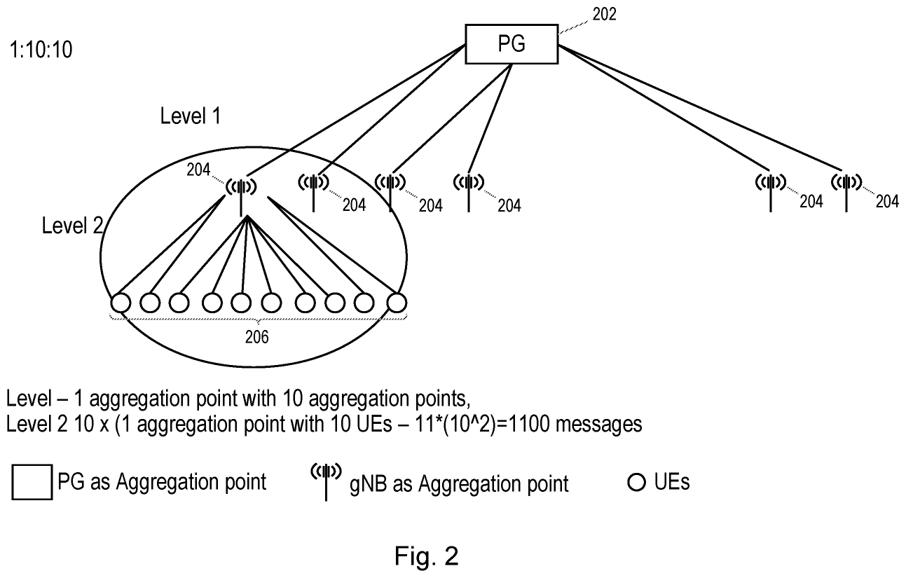

As described in detail below, in embodiments herein, any node of a communications network, such as a gNB, may be used as an aggregator in a distributed learning process. Embodiments herein consider the natural association between user equipments (UEs) and gNBs from a coverage perspective as a natural way of partitioning UEs between nodes acting as aggregation points. This is illustrated in the example communications network shown in FIG. 2 whereby a packet gateway 202 acts as an aggregator towards a plurality of gNBs 204, each gNB acting as an aggregator towards the UEs 206 with which the respective gNB has an established radio channel allocation. This is advantageous compared to more arbitrary partitioning methods that may be determined centrally, e.g. by a datacentre as an exhaustive search does not need to be performed by the datacentre. Using the structure of the network in this way and the mobile phone coverage areas naturally partitions UEs into groups suitable for use in a distributed learning process.

In distributed learning setups, it is typically desirable to learn from others around you, but this can be expensive since you need to maintain that information via gps and also it requires sharing private data (e.g. each devices location). Embodiments herein improve on that by naturally selecting those devices that are in the same or nearby cells (nearby can be determined by way of the MME).

Generally, the methods, systems, nodes and user equipments (UEs) described herein form part of a communications network. A communications network (or telecommunications network) may comprise any one, or any combination of: wired links (e.g. ASDL) or wireless links such as Global System for Mobile Communications (GSM), Wideband Code Division Multiple Access (WCDMA), Long Term Evolution (LTE), WiFi, or Bluetooth wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universals Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

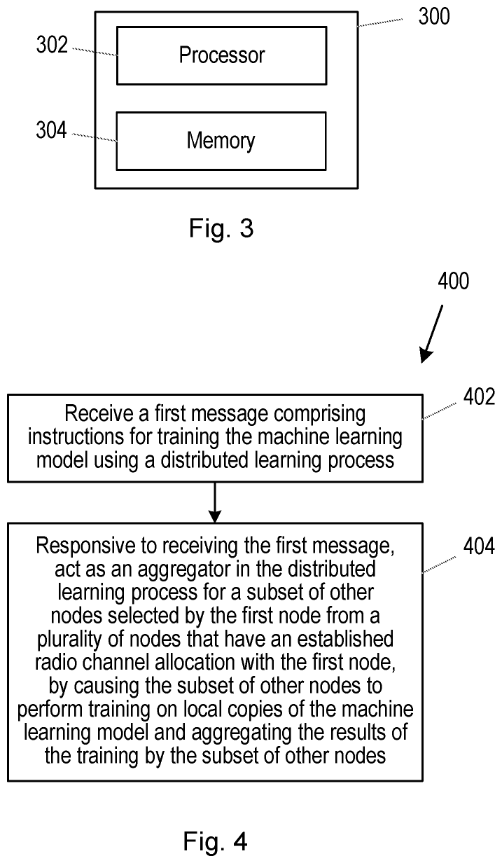

In some embodiments herein there is a first node, such as the node 300 shown in FIG. 3. Generally, the first node 300 may comprise any component or network function (e.g. any hardware or software module) in the communications network suitable for performing the functions described herein. For example, a node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network.

Examples of nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

The first node 300 may be configured or operative to perform the methods and functions described herein, such as the method 400 as described below. The first node 300 may comprise a processor (e.g. processing circuitry or logic) 302. It will be appreciated that the first node 300 may comprise one or more virtual machines running different software and/or processes. The first node 300 may therefore comprise one or more servers, switches and/or storage devices and/or may comprise cloud computing infrastructure or infrastructure configured to perform in a distributed manner, that runs the software and/or processes.

The processor 302 may control the operation of the first node 300 in the manner described herein. The processor 302 can comprise one or more processors, processing units, multi-core processors or modules that are configured or programmed to control the first node 300 in the manner described herein. In particular implementations, the processor 302 can comprise a plurality of software and/or hardware modules that are each configured to perform, or are for performing, individual or multiple steps of the functionality of the first node 300 as described herein.

The first node 300 may comprise a memory 304. In some embodiments, the memory 304 of the first node 300 can be configured to store program code or instructions that can be executed by the processor 302 of the first node 300 to perform the functionality described herein. Alternatively or in addition, the memory 304 of the first node 300 can be configured to store any requests, resources, information, data, signals, or similar that are described herein. The processor 302 of the first node 300 may be configured to control the memory 304 of the first node 300 to store any requests, resources, information, data, signals, or similar that are described herein.

It will be appreciated that the first node 300 may comprise other components in addition or alternatively to those indicated in FIG. 3. For example, in some embodiments, the first node 300 may comprise a communications interface. The communications interface may be for use in communicating with other nodes or UEs in the communications network, (e.g. such as other physical or virtual nodes). For example, the communications interface may be configured to transmit to and/or receive from other nodes or network functions requests, resources, information, data, signals, or similar. The processor 302 of the first node 300 may be configured to control such a communications interface to transmit to and/or receive from other nodes or network functions requests, resources, information, data, signals, or similar.

Briefly, the first node 300 may be configured to receive a first message comprising instructions for training the machine learning model using a distributed learning process. Responsive to receiving the first message, the first node 300 may be configured to act as an aggregator in the distributed learning process for a subset of other nodes selected by the first node from a plurality of nodes that have an established radio channel allocation with the first node, by causing the subset of other nodes to perform training on local copies of the machine learning model and aggregating the results of the training by the subset of other nodes.

FIG. 4 illustrates a computer implemented method 400 in a first node 300 of a communications network for training a machine learning model. The method 400 may be performed by the node 300 described above. Briefly, the method comprises, in a first step (or module) 402, receiving a first message comprising instructions for training the machine learning model using a distributed learning process. In a second step (or module) 404, the method then comprises responsive to receiving the first message, acting as an aggregator in the distributed learning process for a subset of other nodes selected by the first node from a plurality of nodes that have an established radio channel allocation with the first node, by causing the subset of other nodes to perform training on local copies of the machine learning model and aggregating the results of the training by the subset of other nodes.

In more detail, the machine learning model may comprise any type of machine learning model that can be trained using a distributed learning process. Distributed learning processes comprise processes such as, for example, Federated Learning, as described above. Examples of machine learning models include, but are not limited to, supervised learning models such as neural networks or deep neural networks. The skilled person will be familiar with neural networks, but in brief, neural networks are a type of supervised machine learning model that can be trained to predict a desired output for given input data. Neural networks are trained by providing training data comprising example input data and the corresponding “correct” or ground truth outcome that is desired. Neural networks comprise a plurality of layers of neurons, each neuron representing a mathematical operation that is applied to the input data. The output of each layer in the neural network is fed into the next layer to produce an output. For each piece of training data, weights associated with the neurons are adjusted (e.g. using techniques such as back-propagation and gradient descent) until the optimal weightings are found that produce predictions for the training examples that reflect the corresponding ground truths. In this way the neural network is trained to be able to take previously unseen input data and predict an appropriate output. The skilled person will appreciate however that these are merely examples and that other types of distributed learning processes and other types of machine learning models may also be used in embodiments herein, for example, Random Forest Trees and Support Vector Machines.

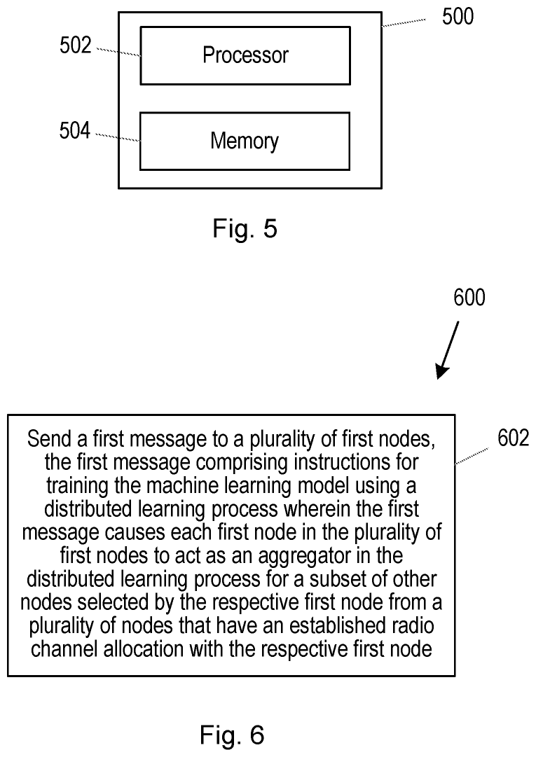

Turning back to the method 400, in the first step 402 the method comprises receiving a first message comprising instructions for training the machine learning model using a distributed learning process. The first message may be received from a second node (as will be described below with respect to FIGS. 5 and 6) in the communications network, such as a packet gateway (PG) 500. The second node may act as an aggregator towards the first node in the hierarchy of the distributed learning process, as will be discussed below.

The instructions may comprise information that can be used to create a copy of the machine learning model. For example, the instructions may comprise an indication of a type of machine learning model, and/or an architecture of the machine learning model. For example, in embodiments where the machine learning model comprises a neural network, the instructions may indicate a number of layers in a neural network and/or one or more parameters (e.g. weights or biases) associated with a neural network. The instructions may further indicate one or more input or output channels for the machine learning model. The instructions may further comprise instructions for training the machine learning model. For example, the instructions may describe the number of training epochs, the batch size of each epoch and/or an optimiser that is to be used to train the machine learning model.

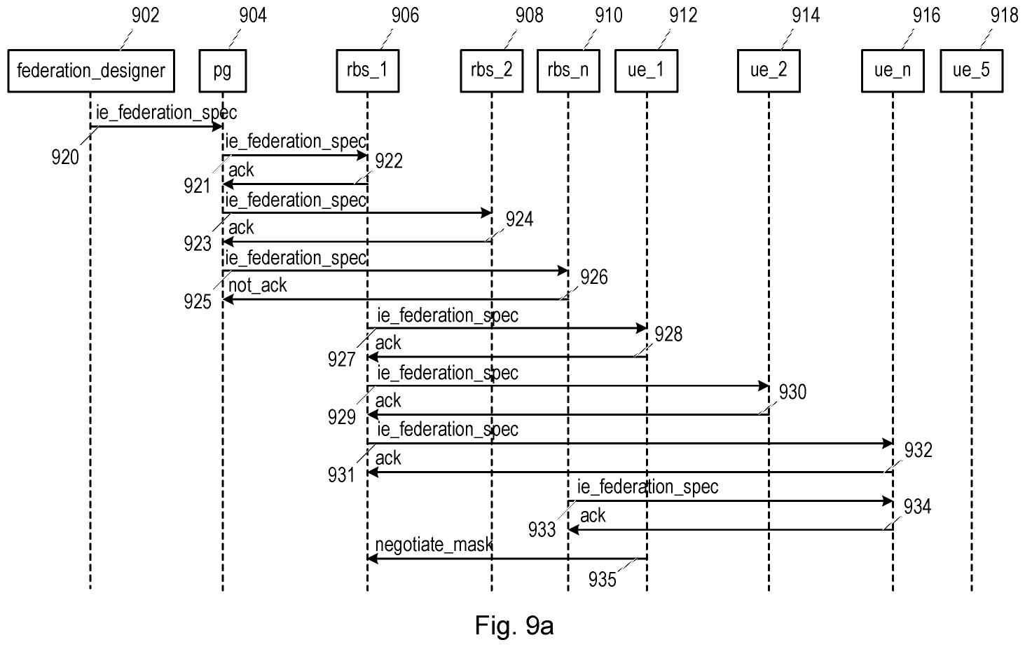

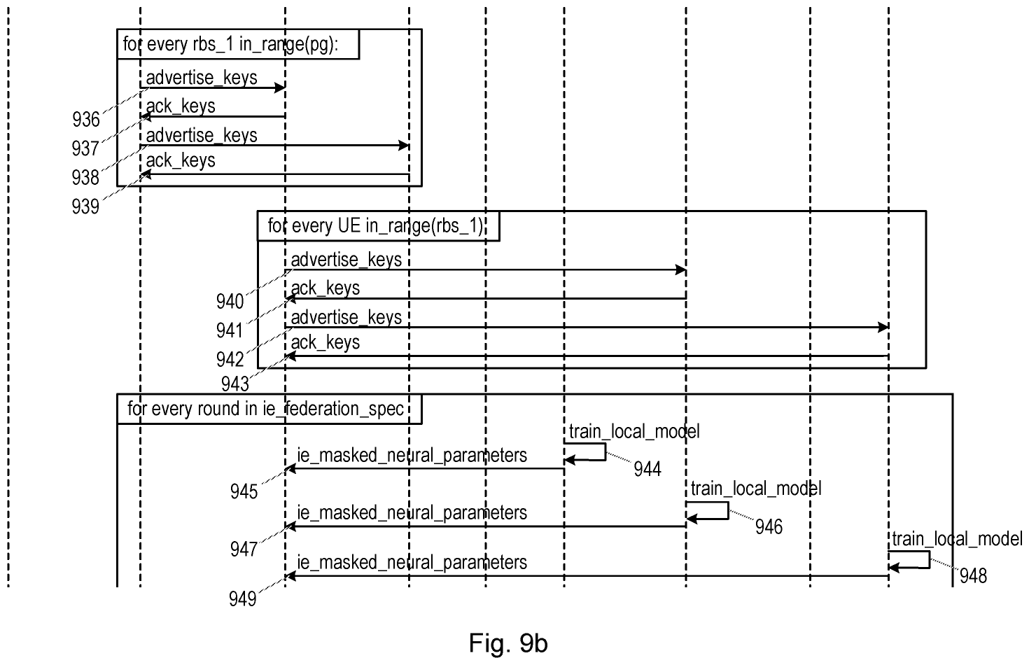

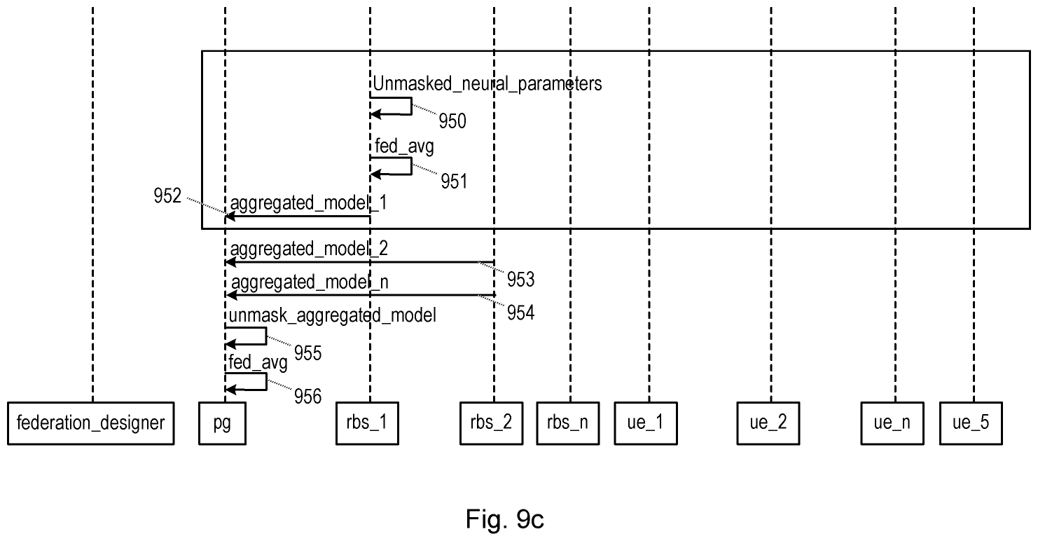

In some embodiments, the first message may comprise an information element such as the information element labelled “ie_federation_spec” as described below with respect to FIGS. 9a-9c. The skilled person will appreciate that this is merely an example however and that the first message may take a different formats and contain different information to that described herein.

In step 404 responsive to receiving the first message, the first node acts as an aggregator in the distributed learning process for a subset of other nodes selected by the first node from a plurality of nodes that have an established radio channel allocation with the first node. In other words, the first node selects nodes from those with which it has an existing radio channel allocation, initiates training of the model in those nodes and acts as an aggregator in the distributed learning process towards the selected nodes. In this way, the node establishes a hierarchy in the distributed learning process, by coordinating nodes within its coverage area. Thus partitioning of the nodes into training or aggregation groups is performed by the nodes themselves, rather than in a centralised manner, e.g. by a datacentre. It is noted that layers further up in the hierarchy (such as a datacentre, or node that initialises the training) of the distributed learning process are thus not necessarily aware of the resulting partitioning as it is determined by the architecture and radio channel allocations within the network.

In this sense, the first node acts as an aggregator in the hierarchy of the distributed learning process and the subset of other nodes act as workers in the hierarchy of the distributed learning process.

In some embodiments, the first message may explicitly instruct the first node to act as an aggregator in the distributed learning process. In other embodiments the first node may be configured (e.g. programmed or adapted) to act as an aggregator, responsive to receiving a message such as the first message.

In some embodiments the subset of other nodes comprise user equipments (UEs). Thus the UEs may train local copies of the machine learning model on data collected by the UEs (e.g. in real time).

In other embodiments, the subset of other nodes may comprise other RBSs (e.g. an RBS may act as an aggregator for training performed by other RBSs). In such an example, local copies of the machine learning model may be created on the other RBSs and training may be performed using internal data that has been captured at the RBS level.

In some embodiments, the step of acting as an aggregator in the distributed learning process may comprise sending a second message to each of the subset of nodes, the second message comprising the instructions for training the machine learning model using the distributed learning process. The second message may initiate the distributed learning process in the subset of nodes.

In some embodiments, the first message may be forwarded without modification (e.g. the second message may comprise, or be the same as, the first message). For example, in some embodiments, the step of acting as an aggregator in the distributed learning process may comprise initiating the distributed learning process in the subset of other nodes by forwarding the first message to the subset of other nodes. As such, the method may comprise propagating the first message to one or more other nodes with which the first node has an established radio channel allocation so as to establish a hierarchy in the distributed learning process whereby the first node acts as an aggregator and aggregates training performed by the subset of other nodes.

In other embodiments, the first node may modify one or more parameters in the first message before sending it on to the subset of other nodes (e.g. the second message may comprise a modified version of the first message). Examples of parameters that may be modified by the first node include but are not limited to fields such as a tolerated drop out rate, or expected duration of training. Such parameters may be modified by the first node, for example, to prevent the first node from being slowed down (or hijacked) by local devices that may take too long to train their local copy of the machine learning model.

In some embodiments, the subset of other nodes comprise all other nodes having an established radio channel allocation with the first node. As such, the step of acting as an aggregator in the distributed learning process may comprise initiating the distributed learning process by forwarding (e.g. propagating) the first message to all other nodes having an established radio channel allocation with the first node. In this manner, the first message inaugurates the distributed learning process, or federation. The first node that receives it becomes an aggregator and then sets up a federation with all other nodes in its coverage area. As will be described in more detail below, this process may be repeated by successive nodes down to UEs, thus setting up a hierarchy for distributed learning throughout the communications network, the layers of which mirror the coverage layers in the communications network itself.

An advantage of this approach is that an exhaustive search does not need to be performed (in the general case, this is a graph partitioning problem which is known to be NP-hard) in order to generate a hierarchy of aggregation points, thus avoiding the limitations of secure aggregation. Moreover, the use of data centers is avoided, thus decreasing the cost of deploying such solutions. This can also offer decreased latency, where there is good enough connectivity between nodes.

In some embodiments, the first node may select a subset of nodes from the plurality of nodes with which it has an existing channel allocation (e.g. rather than forward the first message to all other nodes with which it has an established radio channel allocation). In this sense, the first node may select the other nodes from nodes within the radio coverage area of the first node, or from nodes with which it has an active connection, e.g. nodes with which it is RC connected.

The subset of other nodes may be selected by the first node from the plurality of nodes based on, for example, a criteria related to traffic sent between the first node and each of the other nodes. E.g. volume of traffic, or frequency of traffic. The first node may select the subset of other nodes based on which are most frequently connected, for example. In some embodiments, additionally or alternatively, the subset of other nodes may be selected by the first node based on a user criteria (e.g. a criteria related to a user of each of the other nodes). Actual information about users (i.e. age/sex etc) may be stored in the Home Subscriber Server, HSS. This may be used to select nodes such as UEs, based on demographic criteria (for example, a criteria such as all male users in a certain geographical area). The users may give consent for such usage, otherwise they may remain anonymous.

The first node acts as an aggregator to the subset of other nodes by causing the subset of other nodes to perform training on local copies of the machine learning model and aggregating the results of the training by the subset of other nodes.

In some embodiments, the step of acting as an aggregator in the distributed learning process further comprises receiving a third message from each of the other nodes in the subset of other nodes. Each third message comprising a result of training performed on the machine learning model by the respective other node. The method may then comprise aggregating the results of the training performed by the subset of other nodes.

The skilled person will be familiar with methods of aggregating training performed by a subset of other nodes (e.g. “workers”) in a distributed learning scheme. For example, in embodiments where the machine learning model comprises a neural network, the third message may comprise an indication of one or more parameters associated with the training. For example, one or more values of weights or biases of the neural network. The method may comprise aggregating the results of the training by averaging (e.g. mean, mode, median, or any other averaging method) values of weights or biases of the neural network, received from different ones of the subset of other nodes, for example. As noted above, having the first node act as an aggregator, as opposed to a data centre, may be more efficient as the aggregation is performed closer to the training sites. It may thus reduce training latency.

Thus, in some embodiments, the method 400 may further comprise masking the results of the training. For example, the method may comprise sending a fifth message to each of the other nodes in the subset of other nodes, each fifth message comprising a first parameter that may be used to mask information sent between the first node and the respective other node. The result of the training in each third message may then be masked using the first parameter.

The fifth message(s) may be sent prior to the actual training of the model. Masking may be performed using any secure multi party technique. For example, using a masking or privacy scheme. Examples of masking schemes include, but are not limited to Paillier or Diffie-Helman schemes. In such embodiments, the first parameter may comprise, for example, a key in the Paillier or Diffie-Hellman scheme. Keys may be advertised between the first node and each of the subset of other nodes (e.g. between an RBS and constituent UEs). These keys may be used for masking/unmasking the neural parameters later on and in order to be produced they may be spread among all participants for the purposes of capturing a wider domain of possible random values which are unique to every UE.

Not all neural parameters need to be encrypted, For example, masking may be performed on selected parameters of the machine learning model. Which parameters are selected for masking may depend, for example, on the sensitivity of the information, or third-party requirements (e.g. requirements of a law enforcement agency).

In embodiments where the result of the training in each third message is masked using, for example, a Pallier masking scheme, the step of aggregating the results of the training performed by the subset of nodes may comprise aggregating the masked results of the training. This can improve privacy further because the first node does not need to unmask or decrypt the model parameters (e.g. potentially making them vulnerable to reverse engineering attacks) in order to aggregate the results of the training. In other words, in some embodiments averaging can be performed on top of masked neural parameters.

Masking in this manner may be more efficient, compared to, for example Secure Aggregation techniques described above. As noted above, the complexity of Secure Multi Party Computation techniques, such as Secure Aggregation, increases by O(n²) where n is the number of workers. Conversely, masking according to disclosure herein, essentially allows for setting up federations where the secure multi party computation becomes a parameter (different techniques for secure multi party computation can be used). By making this a negotiation e.g. between base stations and the corresponding UEs, we overcome the cost of negotiating the mask.

Embodiments herein may thus improve on privacy when training a machine learning model using a distributed learning process. As described above, in embodiments herein, mobile networks identify that model transfer takes place. In particular, the distributed learning process becomes partitioned to those devices within the coverage of different cells, thus information is limited there thus further augmenting privacy. Based on the same partitioning, as described above, it is possible to apply a secure multi party computation technique, since this solves the most expensive part of the process which is the selection and the negotiation of “masks” between the participants. This effectively improves on privacy. Even though communication is fully encrypted, the use of secure multi-party computation (mpc) makes it impossible for a user/or process with trusted access within the gnB to read the neural representation of a dataset.

Typically gNBs broker connectivity and don't care much about what's happening in the network (with the exception of video, audio and massive internet of things at different bit rates—this is represented as a QCI class). Since machine learning models may carry information that is sensitive, encryption alone may not be enough to guarantee privacy, however, using the methods outlined herein, private model transfer may be performed without any information being propagated to public data centers, but instead by having the information completely residing between the devices of the network, e.g. using the gNB as a conduit for this process. If a gNB is compromised and if the encryption implemented within the gnB is compromised too—this approach makes it impossible (however compromised) to read the data distribution.

Turning now to other embodiments, as noted above, in some embodiments, the first node may comprise a radio base station (RBS) such as a gNB and the subset of other nodes may comprise UEs. In such embodiments, a new UE may perform a handover procedure to the first node. The new UE may have been part way through training the machine learning model and may have been acting as a worker with respect to a source RBS.

The method 400 may thus further comprise initiating a handover procedure to establish a radio channel allocation with a new UE, and as part of the handover procedure, receiving from the new UE, a third parameter that may be used to mask information sent between the first node and the new UE, such that the first node may act as an aggregator with respect to training performed on the machine learning model by the new UE.

As an example the X2-AP protocol may be used to receive the third parameter. In this manner, the information (mask) may be shared when a UE is allocated to another eNB. Generally in the case of handover, averaging may be performed in the gNB that has already collected the neural parameters or the neural parameters can be moved to the new RBS depending on each RBSs capability to process that information. As noted above, handover (HO) procedures may be used to handover a UE from a source gNB to a target gNB. After the preparation phase of the HO, the source MME may inform the source gNB that the HO preparation is completed, so that the source can inform the UE to perform HO to the target gNB. Once the UE establishes the connection to the target, the target may inform the source that the HO is completed and ask the source to forward any buffered packets to the target (to ensure no data loss). The required information for the distributed learning process, including the Mask can be forwarded at this stage (e.g., piggy-backed to the buffered packets), so that a new negotiation between the UE and the target gNB would not be needed.

Turning now to other embodiments, as was briefly noted above, in step 702, the first message may be received from a second node, such as a PG. The second node may act as an aggregator in the hierarchy of the distributed learning process towards the first node. As such, after the first node has aggregated the results of the training performed by the subset of other nodes, it may report the aggregated results to the second node. The second node may combine or aggregate the aggregated results from the first node with aggregated results received from a third node (e.g. another “first node” performing the method 400).

Thus in some embodiments, the method 400 may further comprise sending a fourth message comprising the aggregated results of the training to the second node for the second node to combine with aggregated results of training from a third node in the communications network.

In some embodiments, the aggregated results may be masked in order to increase privacy. Thus in some embodiments, the method 400 may further comprise receiving from the second node a sixth message comprising a second parameter that may be used to mask information sent between the second node and the first node, and masking the aggregated results of the training in the fourth message, using the second parameter.

The masking may be performed using any of the methods discussed above with respect to the first parameter and the fifth message. For example, the aggregated results of the training may be masked using a scheme such as a Diffie-Helman or Pallier masking scheme and the second parameter may comprise a key in such a scheme. The skilled person will appreciate that this is an example, however and that other masking schemes may also be used.

FIG. 5 illustrates a second node according to some embodiments herein. Generally, the second node 500 may comprise any component or network function (e.g. any hardware or software module) in the communications network suitable for performing the functions described herein. For example, the second node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network.

In some embodiments, the second node may comprise a packet gateway (PG) or Packet Data Network. The skilled person will be familiar with a PG, but in brief, a PG acts as the interface between a Long Term Evolution (LTE) network and other packet data networks. It may, for example, manage quality of service (QoS) and provide deep packet inspection (DPI).

In some embodiments the second node 500 may comprise a Serving Gateway (GW). Generally, a communications network hierarchy starting from the lowest part (e.g. that communicates directly to the UEs) to the highest part (e.g. that has access to other networks) may be comprised as follows. Evolved NodeBs, eNodeBs (to which UEs connect) receive signals from UEs and propagate them further into the Serving Gateway (GW). The Serving Gateway moves user plane traffic from UEs to the Packet Data Network. Packet Data Network (also known as PG) then moves traffic to other networks. Generally, in embodiments herein, the second node 500 may comprise any of these types of nodes including but not limited to, serving gateway (S-GW), Packet Data Network (PDN) or any other gateway (GW), thus according to embodiments herein, any of these nodes may setup a federation with its constituents all the way down to the UEs.

The second node 500 may be configured or operative to perform the methods and functions described herein, such as the method 600 as described below. The second node 500 may comprise a processor (e.g. processing circuitry or logic) 502. It will be appreciated that the second node 500 may comprise one or more virtual machines running different software and/or processes. The second node 500 may therefore comprise one or more servers, switches and/or storage devices and/or may comprise cloud computing infrastructure or infrastructure configured to perform in a distributed manner, that runs the software and/or processes.

The processor 502 may control the operation of the second node 500 in the manner described herein. The processor 502 can comprise one or more processors, processing units, multi-core processors or modules that are configured or programmed to control the second node 500 in the manner described herein. In particular implementations, the processor 502 can comprise a plurality of software and/or hardware modules that are each configured to perform, or are for performing, individual or multiple steps of the functionality of the second node 500 as described herein.

The second node 500 may comprise a memory 504. In some embodiments, the memory 504 of the second node 500 can be configured to store program code or instructions that can be executed by the processor 502 of the second node 500 to perform the functionality described herein. Alternatively or in addition, the memory 504 of the second node 500 can be configured to store any requests, resources, information, data, signals, or similar that are described herein. The processor 502 of the second node 500 may be configured to control the memory 504 of the second node 500 to store any requests, resources, information, data, signals, or similar that are described herein.

It will be appreciated that the second node 500 may comprise other components in addition or alternatively to those indicated in FIG. 5. For example, in some embodiments, the second node 500 may comprise a communications interface. The communications interface may be for use in communicating with other nodes or UEs in the communications network, (e.g. such as other physical or virtual nodes). For example, the communications interface may be configured to transmit to and/or receive from other nodes or network functions requests, resources, information, data, signals, or similar. The processor 502 of the second node 500 may be configured to control such a communications interface to transmit to and/or receive from other nodes or network functions requests, resources, information, data, signals, or similar.

Briefly, the second node 500 may be configured to send a first message to a plurality of first nodes, the first message comprising instructions for training the machine learning model using a distributed learning process wherein the first message causes each first node in the plurality of first nodes to act as an aggregator in the distributed learning process for a subset of other nodes selected by the respective first node from a plurality of nodes that have an established radio channel allocation with the respective first node.

FIG. 6 illustrates a computer implemented method in a second node 500 of a communications network for training a machine learning model. The second node 500 may be configured to perform any of the embodiments of the method 600 as illustrated in FIG. 6. The method 600 is a method performed in a second node of a communications network for training a machine learning model. The method comprises in a first step (or module) 602 sending a first message to a plurality of first nodes, the first message comprising instructions for training the machine learning model using a distributed learning process wherein the first message causes each first node in the plurality of first nodes to act as an aggregator in the distributed learning process for a subset of other nodes selected by the respective first node from a plurality of nodes that have an established radio channel allocation with the respective first node.

In this way, the second node sends the first message to the first node in order to initiate a distributed learning process between the first node and the subset of other nodes with which the first node has an established ratio channel allocation with. The second node does not need visibility of the subset of other nodes (e.g. it does not need to explicitly instruct the first node to act as an aggregator with respect to any particular subset of other nodes), rather the natural association between the first node and the subset of other nodes from a coverage perspective is used as a natural way of partitioning each set of UEs with their corresponding aggregation point. There is no need for the second node to perform a search throughout the network to determine appropriate “worker nodes”, for example. Rather the distributed learning process is initiated by the second node by sending the first message to the first node. The first node then selects the subset of other nodes or “worker nodes” for which it acts as an aggregator in the distributed learning process.

The first node 300, and a method 400 in the first node were described at length with respect to FIGS. 3 and 4 and the detail therein applies equally to the second node 500 and the method 600 in the second node.

In some embodiments, the method 600 may further comprise receiving, from each of the plurality of first nodes, a fourth message comprising aggregated results of training performed by the subset of other nodes with an established radio channel allocation with the respective first node. The method may then comprise acting as an aggregator in the distributed learning process for the plurality of first nodes by aggregating the results of the training as reported in each fourth message. In this manner a second node, such as a packet gateway may co-ordinate and act as an aggregator to aggregate results of training reported by a plurality of first nodes. The first nodes themselves act as aggregators and aggregate training performed by respective subsets of other nodes with which they have established channel allocations, e.g., according to the method 400 above.

In some embodiments, when a first node reports aggregated results of training, this may be masked. For example, the method 600 may further comprise sending a sixth message to each first node in the plurality of first nodes, each sixth message comprising a second parameter that may be used to mask information sent between the second node and the respective first node. The result of the training in each fourth message may then be masked using the second parameter. Masking the transfer of aggregated training between the first and second nodes was described above with respect to the method 400 and the detail therein will be understood to apply equally to the method 600 and the node 500.

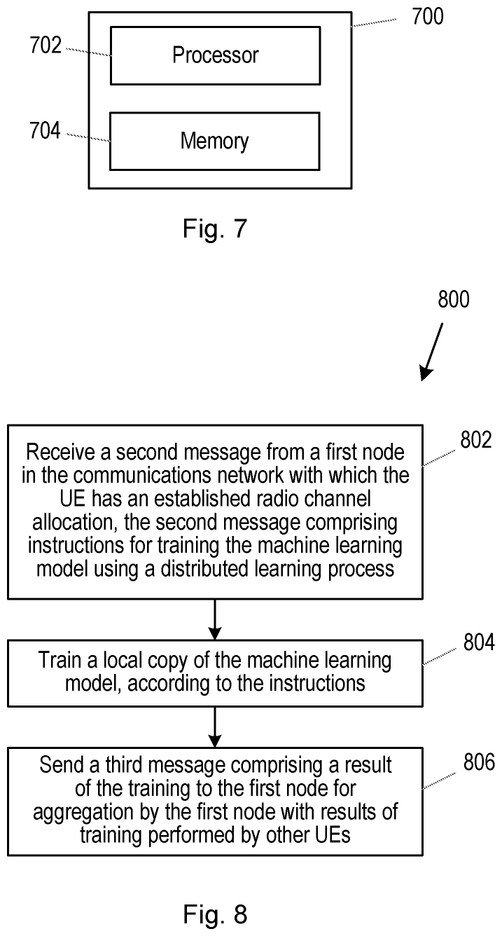

Turning now to other embodiments, FIG. 7 shows a user equipment 700, comprising a processor 702 and a memory 704 according to some embodiments herein. The UE 700 may comprise a device capable, configured, arranged and/or operable to communicate wirelessly with network nodes and/or other wireless devices. Unless otherwise noted, the term UE may be used interchangeably herein with wireless device (WD). Communicating wirelessly may involve transmitting and/or receiving wireless signals using electromagnetic waves, radio waves, infrared waves, and/or other types of signals suitable for conveying information through air.

Examples of a UE 700 include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE 700 as described above may represent the endpoint of a wireless connection, in which case the device may be referred to as a wireless terminal. Furthermore, a UE as described above may be mobile, in which case it may also be referred to as a mobile device or a mobile terminal.

The UE 700 may be configured or operative to perform the methods and functions described herein, such as the method 800 as described below. The UE 700 may comprise processor (or logic) 702. It will be appreciated that the UE 700 may comprise one or more virtual machines running different software and/or processes. The UE 700 may therefore comprise one or more servers, switches and/or storage devices and/or may comprise cloud computing infrastructure or infrastructure configured to perform in a distributed manner, that runs the software and/or processes.

The processor 702 may control the operation of the UE 700 in the manner described herein. The processor 702 can comprise one or more processors, processing units, multi-core processors or modules that are configured or programmed to control the UE 700 in the manner described herein. In particular implementations, the processor 702 can comprise a plurality of software and/or hardware modules that are each configured to perform, or are for performing, individual or multiple steps of the functionality of the UE 700 as described herein.

The UE 700 may comprise a memory 704. In some embodiments, the memory 704 of the UE 700 can be configured to store program code or instructions that can be executed by the processor 702 of the UE 700 to perform the functionality described herein. Alternatively or in addition, the memory 704 of the UE 700, can be configured to store any requests, resources, information, data, signals, or similar that are described herein. The processor 702 of the UE 700 may be configured to control the memory 704 of the UE 700 to store any requests, resources, information, data, signals, or similar that are described herein.

It will be appreciated that the UE 700 may comprise other components in addition or alternatively to those indicated in FIG. 7. For example, the UE 700 may comprise a communications interface. The communications interface may be for use in communicating with other UEs and/or nodes in the communications network, (e.g. such as other physical or virtual nodes such as the node 300 or the node 500 described above). For example, the communications interface may be configured to transmit to and/or receive from nodes or network functions requests, resources, information, data, signals, or similar. The processor 702 of UE 700 may be configured to control such a communications interface to transmit to and/or receive from nodes or network functions requests, resources, information, data, signals, or similar.

Briefly, the memory may comprise instruction data representing a set of instructions. The processor may be configured to communicate with the memory and to execute the set of instructions. The set of instructions, when executed by the processor, may cause the processor to receive a second message from a first node, in the communications network with which the UE has an established radio channel allocation, the second message comprising instructions for training the machine learning model using a distributed learning process; train a local copy of the machine learning model, according to the instructions; and send a third message comprising a result of the training to the first node for aggregation by the first node with results of training performed by other UEs.

FIG. 8 shows a computer implemented method in a UE 800 according to some embodiments. In this method, in a first step (or module) 802 the method comprises receiving a second message from a first node in the communications network with which the UE has an established radio channel allocation, the second message comprising instructions for training the machine learning model using a distributed learning process. In a second step (or module) 804 the method comprises training a local copy of the machine learning model, according to the instructions. In a third step (or module) 806 the method comprises sending a third message comprising a result of the training to the first node for aggregation by the first node with results of training performed by other UEs.

The UE thus acts as a worker for the first node with which it already has an existing radio channel allocation. The UE sends the results of the training to the first node for the first node to aggregate with results of training from other UEs. This is more efficient than if the UE were to send the results of the training to a centralised data centre, for example, resulting in lower training latency of the machine learning model.

The first node 400 and the first message were discussed in detail above with respect to FIGS. 4 and 5 above and the detail therein will be understood to apply equally to the UE 700 and the method 800.

As described above, in some embodiments the results of training performed by a UE are masked before being sent to the first node (e.g. RBS). In some embodiments, therefore, the method 800 may further receiving a fifth message comprising a first parameter that may be used to mask information sent to the first node. The step of sending 806 a third message comprising a result of the training may further comprise masking the result of the training using the first parameter.

If the UE performs a handover procedure from the first node to a new node part way through the training of the machine learning model (e.g. during step 804), the training may be continued by the new node. For example, the new node may act as aggregator for subsequent training performed by the UE. In some embodiments the method 800 may further comprise performing a handover procedure from the first node to a new node, and as part of the handover procedure, sending the first parameter to the new node. In this manner, the parameters needed to move the UE from the federation of the first node to the second node may be transferred during handover. This ensures a smooth transition and minimises any additional signal overhead that would otherwise be needed to either maintain the UE in the federation of the first node (e.g. keep the first node as aggregator for training performed by the UE) or to exchange masking parameters or keys between the new node and the UE as part of a separate signalling procedure.

Turning now to FIGS. 9a, 9b and 9c, which illustrate a method of training a machine learning model according to an embodiment herein. In this embodiment, the first node comprises a first RBS 906, the second node comprises a packet gateway 904 and the subset of other nodes comprise a subset of UEs 912, 914, 916 having an established channel connection with the first RBS 906. In the example of FIG. 9, the machine learning model comprises a neural network, however it will be appreciated that this embodiment also applies to training other types of machine learning model. In this embodiment, the PG performs the method 600 as described above, RBSs 906, 908 and 910 each perform the method 400 as described above and the UEs 912, 914 and 916 each perform the method 800 as described above.

In this embodiment, the “first message” as described above, comprises an information element “ie_federation_spec”, the format of which is provided in Appendix I. The training of the machine learning model is performed using a distributed learning method and initiated by a node 902, the Federation Designer (which may comprise, for example, a central control node). A user may initiate the training of the machine learning model from the Federation Designer node 902. The federation designer 902 disseminates (e.g. sends or propagates) the federation spec information element to a packet gateway 904 in a message 920. Only one packet gateway is illustrated in FIG. 9 but it will be appreciated that the federation_designer 902 may send the message 920 to a plurality of packet gateways.

The ie_federation_spec comprises instructions for training the machine learning model using a distributed learning process and describes the details of the distributed learning process, such as, for example, the neural parameters (initial weights, combined with the architecture of the neural network), the number of epochs for the training process, the batch size, the optimizer to be used, information about the data split between train set and test set, expected amount of workers, geographical coverage, tolerance in case of failures or dropouts from different participating UEs and the expected amount of rounds for the federation to converge to a desired level of accuracy metric (metrics vary from use case to use case, examples are roc_auc or r2_score).

In this embodiment, the PG forwards the ie_federation_spec (the “first message” as referred to above) to RBSs 906, 908, 910 (in messages 921, 923 and 925 respectively) with which it has an established radio channel allocation with. The RBSs may send acknowledgements of receipt of the first message 922, 924, 926. In this example RBS 910 sends a message indicating that it declines to join the distributed learning process (“Not_ack” message 926).

Responsive to receiving the first message, RBS 906 acts as an aggregator in the distributed learning process towards the subset of UEs 912, 914, 916 selected by RBS 906 from a plurality of UEs that have an established radio channel allocation with the RBS 906. The RBS 906 causes the subset of UEs 912, 914, 916 to perform training on local copies of the machine learning model and aggregates the results of the training. In this embodiment, the RBS 906 acts as an aggregator in the distributed learning process by initiating the distributed learning process in the UEs 912, 914, 916 by forwarding the first message (in respective “second messages” 927, 929, 931) to the subset of UEs 912, 914, 916. The UEs acknowledge receipt of the second messages in acknowledgement messages 928, 930 and 932. RBS 908 performs an equivalent procedure with respect to another subset of UEs with which it has an established radio channel allocation (not shown in FIG. 9a-c for clarity).

Prior to the actual training of the model, keys are advertised between the RBS 906 and the UEs 912, 914, 916. These keys will be used for masking/unmaksing the neural parameters later on and in order to be produced they need to be spread among all participants for the purposes of capturing a wider domain of possible random value which are unique to every UE. In its simplest form this spread can be captured as such—10 participants [−10, +30, −21, +41, −84, −128, −39, +0.5922324, +9]. Based on this negotiation, every participant agrees to mask (module, shifting, prime number factorization) their neural parameters using the corresponding value from that array (array is produced randomly by asking every participants input). Only the aggregation point knows this information and only they can use it to unmask expected neural parameters at every stage where fed_avg takes place. The keys are sent as “first parameters” in messages 940, 942 (respective “fifth messages” as described above) to each of the UEs. The keys may be used to mask information sent between the RBS 906 and the respective UEs 912, 914, 916.

The UEs 912, 914, 916 perform training 944, 946 and 948 on the machine learning model according to the instructions received in the messages 927, 929, 931. UEs 912, 914, 916 then mask the results of the training, e.g. the updated neural parameters using the keys sent in messages in 940 and 942 and send the masked neural parameters to the RBS 906 (in respective “third messages” as described above) in messages 945, 947 and 948. In this embodiment, the masked neural parameters are sent in an information element “ie_masked_neural_parameters” as illustrated in Appendix I.

RBS may 906 may unmask 950 the results of the training (e.g. neural parameters) using the keys and aggregate the results of the training performed by the UEs in a federated averaging procedure 951.

The federation is performed locally for n rounds between the gNB and the connected UEs. Once each federation is complete at the RBS 906 and UE 912, 914, 916 level, a subsequent federation takes place between the RBS and the Packet Gateway, ultimately producing the final aggregated model.

In a similar manner to the advertisement of keys between the RBS 906 and the UEs 912, 914, 916, keys may also be advertised between the PG 904 and respective RBSs 906, 908 in messages 936, 938. These may be acknowledged by the RBSs in acknowledgement messages 937 and 939 and used to send the aggregated models determined in step 956 to the PG in a messages 952, 953 and 954.

The PG may unmask 955 the averaged results of the training (e.g. neural parameters) using the keys and aggregate the averaged results of the training as reported by the RBSs 906, 908, 910 in a federated averaging procedure 956.

With respect to the information elements described in Appendix I, Packet processing flow in the User Plane Function (UPF) is described in 3GPP TS29.244. The flow connects a UE's Packet Forwarding Control Protocol (PFCP) session (a unique identifier which is acquired as soon as UE has established it's connection with a gNB) with a Packet Data Rule (or PDR) which would then act on the aforementioned information elements to unpack incoming traffic from the UE and perform the averaging operation in the case where that process will take place inside the network (NW).

A PDR consists of→
1) Packet Detection Information (the information element identifier is used in embodiments herein)
2) FAR (Forwarding action rule) (in embodiments herein, packets are forwarded in the case where averaging will take place in a data center or when model averaging has been completed)
3) BAR (Buffering action rule) (this is typically used for handover purposes—herein this may be used to accumulate the models that are to be aggregated)
4) QER (QoS enforcement)—this is optional—it may be used in some embodiments to give the distributed learning process a higher priority.
5) URR (Usage reporting rule)—this is an OSS function used for accounting purposes I.e. charging/analytics etc.

In the case where a first or second node (e.g. a gNB or Packet Gateway) cannot handle the number of models that are being transferred/averaged, in some embodiments it may be possible to fallback to a data center and as such request resource allocation and forward traffic there. This approach makes what is proposed here backwards compatible with what is already available in the state of the art, however, in embodiments herein, the decision about this resource allocation and also the proximity of the data center is handled by the telecommunication networks rather than by the designer of the application.

Turning now to another embodiment, there is a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### Appendix I

For the purposes of this disclosure, two information elements are defined, following the 3GPP defined information element format (TLV—Type, Length, Value).

| | Bits | | | | | | | |
|---|---|---|---|---|---|---|---|---|
| Octets | 8 | 7 | 6 | 5 | 4 | 3 | 2 | 1 |

| | |
|---|---|
| 1 to 2 | Type = xxx (decimal) |
| 3 to 4 | Length = n |
| 5 to (n + 4) | IE specific data or content of a grouped IE |

Information element: ie federation spec:
a. type [within range of 249 to 32767 which is reserved for future use]
b. Length—variable length depending on value
c. Value—example without loss of generality (example in YAML format)
   i. federation_spec:
   ii. experiment_id: [name_of_the_experiment]
   iii. start_time: [time_when_the_fedearation_will_start]
   iv. epochs: [training_epochs]
   v. batch_size: [batch_size]
   vi. optimizer: [optimizer, i.e. adam, sgd etc]
   vii. optimizer_params: [loss_metric, learning_rate]
   viii. train_test_split_ratio: [percentage i.e. 0.6]
   ix. model_arch: {model: {class_name: Sequential, config: {name: sequential, layers: [{class_name: Dense, config: {name: dense, trainable: true, batch_input_shape: [null, 69], dtype: float32, units: 32, activation: relu, use_bias: true, kernel_initializer: {class_name: GlorotUniform, config: {seed: null, dtype: float32}}, bias_initializer: . . . }
   x. neural_parameters: numpy.ndarray”, “shape”: [69, 32], “values”: “eJwNl49fz . . . ”
   xi. rounds: 20
   xii. accuracy_metric: roc_auc_score
   xiii. accepted_accuracy_threshold: 70
   xiv. expected_duration: 1 m
   xv. actual duration:
xvi. tolerated_drop_out: 30
   xvii. privacy_method: (paillier/secure_aggregation/differential privacy)

### Information Element: Masked Neural Parameters

a. type [within range of 249 to 32767 which is reserved for future use]
b. length—[length of value]
c. masked_neural_parameters (example in YAML format)
   xviii. masked_neural_parameters:
   xix. experiment_id: [name_of_the_experiment]
   xx. timestamp: [time_when_the_neural_parameters_have_been_produced]
   xxi. masked_neural_parameters: numpy.ndarray”, “shape”: [69, 32], “values”: “eJwN149fz . . . ”
   xxii. round: [round_that_produced_these_parameters]
   xxiii. feature_distribution: encoded_normalized
   xxiv. privacy_method: (paillier/secure_aggregation/differential privbacy)
   v, V public key: [in_case_of_paillier]

1. A method in a first node of a communications network for training a machine learning model, the method comprising:
receiving a first message comprising instructions for training the machine learning model using a distributed learning process;
responsive to receiving the first message, acting as an aggregator in the distributed learning process for a subset of other nodes selected by the first node from a plurality of nodes that have an established radio channel allocation with the first node, by causing the subset of other nodes to perform training on local copies of the machine learning model and aggregating the results of the training by the subset of other nodes.

2. A method as in claim 1 wherein the step of acting as an aggregator in the distributed learning process comprises:
initiating the distributed learning process in the subset of other nodes by forwarding the first message to the subset of other nodes.

3. A method as in claim 2 wherein the subset of other nodes comprise all other nodes having an established radio channel allocation with the first node and wherein the step of acting as an aggregator in the distributed learning process comprises:
initiating the distributed learning process by forwarding the first message to all other nodes having an established radio channel allocation with the first node.

4. A method as in claim 1 wherein the subset of other nodes are selected by the first node from the plurality of nodes based on one or more of:
a criteria related to traffic sent between the first node and each of the other nodes; and
a criteria related to a user of each of the other nodes.

5. A method as in claim 1 wherein the step of acting as an aggregator in the distributed learning process further comprises:
receiving a third message from each of the other nodes in the subset of other nodes, each third message comprising a result of training performed on the machine learning model by the respective other node; and
aggregating the results of the training performed by the subset of other nodes.

6. A method as in claim 5 further comprising sending a fifth message to each of the other nodes in the subset of other nodes, each fifth message comprising a first parameter that may be used to mask information sent between the first node and the respective other node; and
wherein the result of the training in each third message is masked using the first parameter.

7. A method as in claim 1 wherein the first message is received from a second node and wherein the method further comprises:
sending a fourth message comprising the aggregated results of the training to the second node for the second node to combine with aggregated results of training from a third node in the communications network.

8. A method as in claim 7 further comprising receiving from the second node a sixth message comprising a second parameter that may be used to mask information sent between the second node and the first node; and
masking the aggregated results of the training in the fourth message, using the second parameter.

9. A method as in claim 7 wherein the second node comprises a packet gateway, PG.

10. A method as in claim 1 wherein the first node comprises a first radio base station, RBS, evolved NodeB, eNB, or New Radio NodeB, gNB.

11. A method as in claim 1 wherein the subset of other nodes comprise user equipments, UEs.

12. A method as in claim 11 further comprising:
initiating a handover procedure to establish a radio channel allocation with a new UE; and
as part of the handover procedure, receiving from the new UE, a third parameter that may be used to mask information sent between the first node and the new UE, such that the first node may act as an aggregator with respect to training performed on the machine learning model by the new UE.

13. A method in a second node of a communications network for training a machine learning model, the method comprising:
sending a first message to a plurality of first nodes, the first message comprising instructions for training the machine learning model using a distributed learning process, wherein the first message causes each first node in the plurality of first nodes to act as an aggregator in the distributed learning process for a subset of other nodes selected by the respective first node from a plurality of nodes that have an established radio channel allocation with the respective first node.

14. A method as in claim 13 further comprising:
receiving, from each of the plurality of first nodes, a fourth message comprising aggregated results of training performed by the subset of other nodes with an established radio channel allocation with the respective first node; and
acting as an aggregator in the distributed learning process for the plurality of first nodes by aggregating the results of the training as reported in each fourth message.

15. A method as in claim 14 further comprising sending a sixth message to each first node in the plurality of first nodes, each sixth message comprising a second parameter that may be used to mask information sent between the second node and the respective first node; and
wherein the result of the training in each fourth message is masked using the second parameter.

16. A method as in any one of claim 13 wherein the second node comprises a packet gateway, PG.

17. A method in a user equipment, UE, of a communications network for training a machine learning model, the method comprising:
receiving a second message from a first node in the communications network with which the UE has an established radio channel allocation, the second message comprising instructions for training the machine learning model using a distributed learning process;
training a local copy of the machine learning model, according to the instructions; and
sending a third message comprising a result of the training to the first node for aggregation by the first node with results of training performed by other UEs.

18. A method as in claim 17 further comprising receiving a fifth message comprising a first parameter that may be used to mask information sent to the first node; and
wherein the step of sending a third message comprising a result of the training comprises masking the result of the training using the first parameter.

19. A method as in claim 18 wherein the method further comprises:
performing a handover procedure from the first node to a new node; and
as part of the handover procedure, sending the first parameter to the new node.

20. (canceled)

21. A first node in a communications network for training a machine learning model, the first node comprising:
a memory comprising instruction data representing a set of instructions; and
a processor configured to communicate with the memory and to execute the set of instructions, wherein the set of instructions, when executed by the processor, cause the processor to:
receive a first message comprising instructions for training the machine learning model using a distributed learning process; and
responsive to receiving the first message, act as an aggregator in the distributed learning process for a subset of other nodes selected by the first node from a plurality of nodes that have an established radio channel allocation with the first node, by causing the subset of other nodes to perform training on local copies of the machine learning model and aggregating the results of the training by the subset of other nodes.

22-29. (canceled)
